(19) United States
(12) Patent Application Publication
(10) Pub. No.: US 2016/0168889 A1
(43) Pub. Date: Jun. 16, 2016

(54) Post for two section folding closure and folding closure using same

(71) Applicant: Julian Michael Svenson, Cornwall (CA)

(72) Inventor: Julian Michael Svenson, Cornwall (CA)

(21) Appl. No.: 14/544,831

(22) Filed: Feb. 24, 2015

(30) Foreign Application Priority Data
Dec. 11, 2014 (CA) 2874347

(51) Int. Cl. E05C 7/04; E06B 3/48; E05D 15/06; E06B 3/00

(52) U.S. Cl. CPC E05C 7/04; E06B 3/00; E06B 3/487; E05D 15/0652; E05C 2007/007

(57) ABSTRACT

A female locking post for the free end of a folding closure section, with an inner side for connecting the post to the free end, and an outer side opposite the inner side. Two opposed connecting walls connect the inner and outer sides together. An interior wall, spaced from both the inner and outer sides, extends between the connecting walls. A post opening, preferably extending the length of the post, is provided in the outer side between the connecting walls providing access to the interior wall. An operator with a lock bolt is movably mounted on the interior wall, the operator movable along the interior wall between an unlocked position where the lock bolt is within the post and a locked position where the lock bolt projects from an end of the post. A folding closure incorporating the female post is also described.

### BACKGROUND OF THE INVENTION

1) Field of the Invention

This invention is directed to an female locking post for use on a first section of a two-section folding closure. The invention is also directed toward a two-section folding closure with a female locking post on the free end of one of the sections for use in locking the sections together in a closed position of the closure.

2) Description of the Related Art

Two-section folding closures are used to close wide openings within buildings with one section of the closure mounted on one side of the opening and the other section mounted on the other side of the opening. Using two sections in the closure permits easier installation and handling of the closure and also allows the use of a smaller storage space for each section on each side of the opening. Each section has a locking post at its free end. One of the locking posts has a lock bolt, within the post, for use in locking the one end of the one section to the floor of the building. The other locking post on the other section has a lock to lock the other post to the one post. The lock bolt on the one post normally has an external operator for moving it. On longer closures, the lock bolt, being operable from outside the post, could be unlocked from the floor and the closure could be swung laterally, to raise the bottom of the closure enough to allow entry under the closure. Thus two section closures are limited in their length so that they can be used in a secure manner. An external operator on the locking post for the lock bolt also limits the versatility of the post since the operator, on one side of the post, should always be located on the inside of the closure, and often cannot be. An external operator also is vulnerable to damage.

### SUMMARY OF THE INVENTION

It is one object of the present invention to provide a locking post that has an internal operator for a lock bolt on the post thus making a folding closure using the locking post more secure. It is another object of the present invention to provide an operator for the lock bolt that is generally centrally mounted on the locking post between the walls of the post connecting the inner and outer sides of the post to provide more versatility in using the post. It is another object of the present invention to provide an operator for the locking post that is less likely to be damaged.

In one aspect, the present invention is directed toward a female locking post for the free end of a first folding closure section in a two section folding closure. The female post has an inner side and an outer side. The inner side of the post is an inner wall for use in connecting the post to the free end of the first folding section, the inner wall having two longitudinally opposed edges. Two opposed connecting walls, each joined to a respective one of the edges of the inner wall, extend from the inner wall of the post to its outer side. An interior wall extends between, and is joined to, the connecting walls, the interior wall spaced from both the inner wall and the outer side. The outer side of the post has at least a partial post opening. An operator, with a lock bolt, is movably mounted on the interior wall in a position where it is accessible through the post opening in the outer side. The operator is manually movable, through the post opening, along the interior wall, in a longitudinal direction, between an unlocked position where the lock bolt is within the post, and a locked position where the lock bolt projects from an end of the post.

In another aspect, the present invention is also directed to a folding closure for closing an opening in a building. The folding closure comprises first and second folding sections having structure along a top thereof for suspending the sections from an overhead rail at the top of the building opening, each section having one end configured for fastening the section to a respective side of the building opening and an opposed free end. A female locking post is connected by an inner side to the free end of the first folding section and a male locking post is connected to the free end of the second folding section. The female post has an outer side opposite its inner side, the outer side facing the male locking post. The outer side has at least a partial post opening. The female post has an operator, with a lock bolt, within the post at a bottom end of the post for locking the first folding section to a floor in the building, the operator operable through the post opening in the outer side of the female post. The male locking post is movable to the female locking post to close the post opening in the outer side of the female post when joining the sections together to close the building opening. The posts have cooperating locking members for locking the male locking post to the female locking post.

### BRIEF DESCRIPTION OF SEVERAL VIEWS OF THE DRAWINGS

FIG. 1 is a cross-section view of the female locking post taken along line 1-1 in FIG. 2 with a male post shown partly inserted within the female post;

FIG. 2 is a front view of the bottom portion of the female locking post in an unlocked position;

FIG. 3 is a front view of the bottom portion of the female locking post in an unlocked position with a cover plate removed;

FIG. 4 is the same view as FIG. 3 but with the female locking post in a locked position;

FIG. 5 is a side view of the operator used on the female post;

FIG. 6 is a plan view of the operator;

FIG. 7 is a cross-section view of the operator taken along line 7-7 in FIG. 6;

FIG. 8 is a cross-section view of the female post taken along line 8-8 in FIG. 2;

FIG. 9 is a detail cross-section view of the operator;

FIG. 10 is a detail cross-section view of the operator with a lock member in place in the operator;

FIG. 11 is a detail cross-section view showing the lock member on the operator in a locking position;

FIG. 12 is a front elevation view of a two-section closure using the female post;

FIG. 13 is a schematic, detail, cross-section view showing the free ends of the two closure sections in the closure just before joining together;

FIG. 14 is a view similar to FIG. 13 but with the free ends of the two closure sections joined;

FIG. 15 is a partially cut-away, detail view showing locking members for joining the free ends of the two closure sections together;

FIG. 16 is a cross-section view of a modified female post; and

FIG. 17 is a cross section view of another modified female post.

### DETAILED DESCRIPTION OF THE INVENTION

In the present application, a female locking post is intended to mean a post having a generally quadratic cross-sectional shape that has at least a partial, longitudinal, post opening in an outer side of the post, extending the length of the post, through which a male locking post can be at least partially inserted to enter the female locking post and to close the post opening.

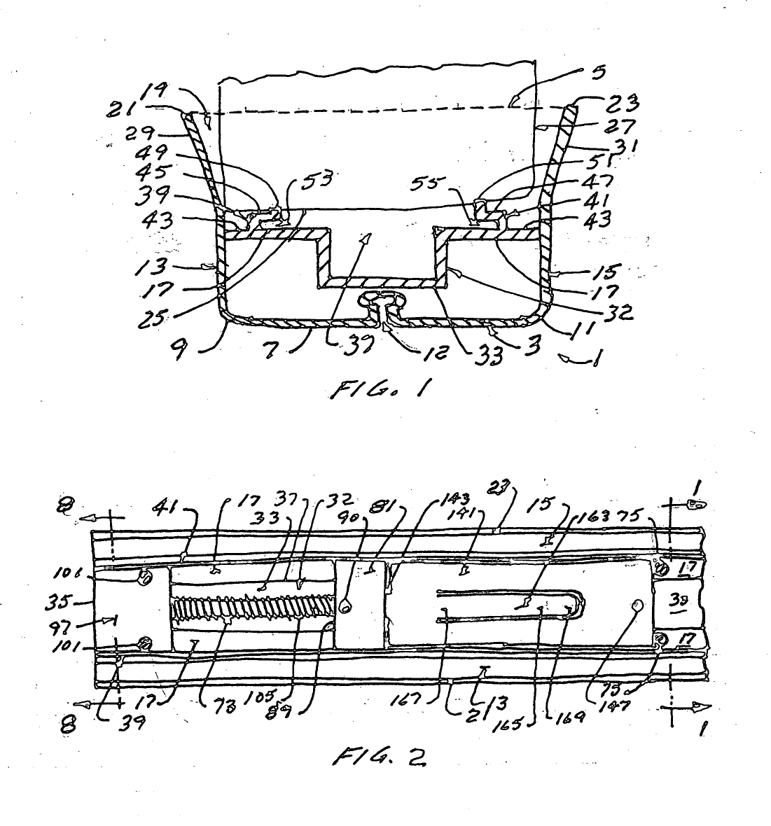

Referring to FIG. 1, a female locking post 1 of a particular embodiment of the present invention has an inner side 3, and an opposite outer side 5, shown by dash lines, spaced from and generally parallel to the inner side 3. The inner side 3 is formed by an inner wall 7 having parallel, longitudinal edges 9, 11. The center of the inner wall 7 has a longitudinal slot 12 extending the length of the female post 1, the slot used to connect the female post 1 to the outer end of a first folding closure section in a folding closure in a known manner. A pair of connecting walls 13, 15 extend outwardly from the edges 9, 11 respectively of the inner wall 7 to the outer side 5, the connecting walls 13, 15 generally transverse to the inner wall 7 and the outer side 5. An interior wall 17 extends between, and is joined to, the connecting walls 13, 15, the interior wall 17 spaced from both the inner wall 7 and the outer side 5.

The outer side 5 of the female locking post 1 has at least a partial post opening 19 extending the length of the post between the ends of the post. The post opening 19 in this particular embodiment is normally as wide as the outer side 5 and extends between the free ends 21, 23 of the connecting walls 13, 15 respectively. The post opening 19 provides access to the interior wall 17 in the female post 1. The post opening 19 is also just wide enough to pass the leading end 25 of a male locking post 27, mounted on the free end of a second folding closure section of the folding closure as will be described, into the female post 1 to close the post opening 19. To facilitate entry of the male post 27 through the post opening 19 into the female post 1, the outer portions 29, 31 of the connecting walls 13, 15 may slightly diverge from each other as shown.

In the embodiment shown in FIGS. 1-4, the interior wall 17 has a central, longitudinally extending, guide structure 32 such as a channel 33. The channel 33 extends up from the bottom end 35 of the female post 1, as shown in FIG. 2 and extends the length of the post. It should be noted that FIGS. 2-4 show the female post 1 in a horizontal position while this description describes the female post 1 in its normal vertical position during use. The channel 33 has a quadratic cross-section and extends toward the inner wall 7 from the interior wall 17. The channel 33 is open toward the outer side 5 providing a longitudinal wall opening 37 in the interior wall 17. The interior wall 17 also has longitudinal locating members 39, 41, one on each side of the wall opening 37 as shown in FIG. 1, extending outwardly from the outer surface 43 of the interior wall 17 toward the outer side 5. Each locating member 39, 41 has a short shoulder 45, 47 respectively, about midway of its height, extending toward the other locating member. The free ends 49, 51 of the locating members 39, 41 respectively can serve to locate the lead end 25 of the male locking post when it is connected to the female post 1 as will be described. The shoulders 45, 47 form, with the interior wall 17, a channel 53, 55 on each side of the wall opening 37, the channels 53, 55 facing each other. The configuration of the locating members 39, 41 could vary.

The female locking post 1, as shown in FIGS. 2-4, carries an operator 67 at the bottom portion of the post adjacent the one end 35 of the post which end is the bottom end when the post is installed in a vertical position on a folding closure section. The operator 67 fits snugly in the channel 33 in the post 1 and is longitudinally slidable in the channel 33 in the particular embodiment. The operator 67 has a generally elongated block-shaped body 71. A lock bolt 73 is mounted at one end of the operator 67 and projects from the one end of the operator 67 toward the bottom end 35 of the female post 1 when the operator 67 is in the channel 33. The combined operator 67 and lock bolt 73 extends generally from the bottom end 35 of the female post 1 to one or more stoppers 75, defined for example by a pair of fasteners 77, in the interior wall 17, one on each side of the channel 33, the fasteners 77 extending outwardly from the wall 17. In the particular embodiment, the stoppers 75 are roughly a foot from the bottom end 35 of the post. The stoppers 75 limit upward movement of the operator 67 on the post. It is understood that any other appropriate type of stopper(s) can alternately be used.

The operator 67, when installed, has, as shown in FIGS. 5-7, a lower guide section 81 where the lock bolt 73 joins the operator, and an upper guide section 83 at the upper end of the operator. The lower guide section 81 has lateral wings 85 which ride on the outer surface 43 of the interior wall 17 and extend into the channels 53, 55 under the shoulders 45, 47 of the locating members 39, 41 respectively to help guide and retain the operator 67 in the channel 33. A bore 87 extends into the lower guide section 81 from the bottom 89 of the operator 67 to receive the upper end of the lock bolt 73. A fastener 90 threaded through a hole 91 in the lower guide section 81 can detachably secure the lock bolt 73 in the operator. The upper guide section 83 has lateral wings 93 which also ride on the outer surface 43 of the interior wall 17 and extend into the channels 53, 55 to help retain the operator 67 in the channel 33.

The female locking post 1, as shown in FIGS. 2-4 and 8, has a lock bolt guide 97 at the bottom end 35 of the female post 1 extending across the channel 33. The lock bolt guide 97 has lateral wings 99, as shown in FIG. 8, extending into the channels 53, 55, the wings 99 on the outer surface 43 of the interior wall 17 and fastened to the wall 17 by suitable fasteners 101, such as screws. The lock bolt guide 97 has a cylindrical portion 103 between the wings 99 partly within the channel 33 through which the lower end of the lock bolt 73 slides and is supported and guided. A return, compression spring 105 is mounted on the lock bolt 73 to extend between the lock bolt guide 97 and the lower guide section 81 of the operator 67 as seen in FIG. 2. The spring 105 is slightly compressed to bias the operator 67 up against the stoppers 75, with the lock bolt 73 just within the female post 1, in the unlocked position of the operator.

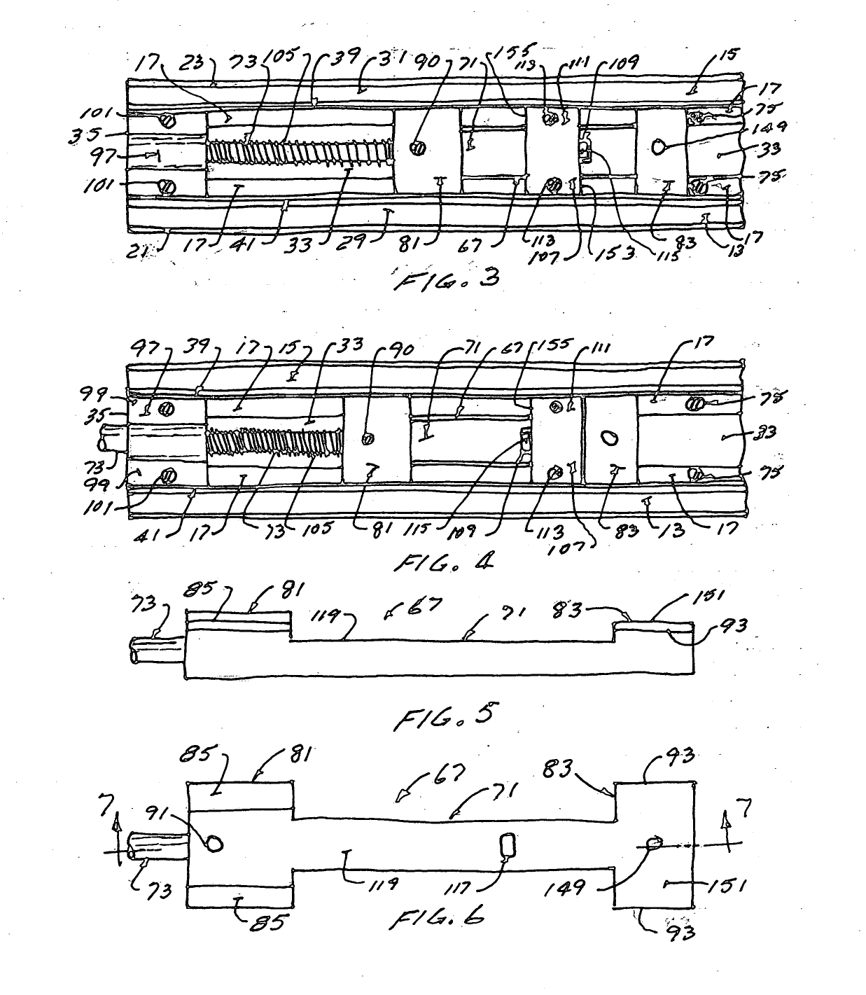

Referring to FIGS. 9-11, cooperating locking mechanisms 107, 109 are provided on the interior wall 17 of the female post 1 and the operator 67 respectively for retaining the operator 67 and thus the lock bolt 73 in a locked position. The configuration of the locking mechanisms may vary. In the embodiment shown, the locking mechanism 107 on the interior wall 17 comprises a stop plate 111, as also seen in FIGS. 3-4, above the lower guide section guide 81 extending across the channel 33 about at the middle of the lock block 71. The stop plate 111 is about midway between the lower and upper guide sections 81, 83, when the lock bolt 73 is within the post in an unlocked position. The stop plate 111 extends into the channels 53, 55 on the interior wall 17 and is fastened to the interior wall 17 on either side of the channel 33 by suitable fasteners 113 such as screws. The stop plate 111 is on the outer surface 43 of the interior wall 17 facing the outer side 5 of the female post 1.

In a particular embodiment, and as shown in FIGS. 9-11, the locking mechanism 109 on the operator 67 has a lock member 115, in the shape of a rectangular block. The locking mechanism 109 includes a cavity 117 in the body 71 of the operator 67 with an entrance 118 in the side surface 119 of the body 71 that faces the outer side 5 of the female post 1 providing access to the cavity 117. The lock member 115 is mounted in the cavity 117. The cavity 117 is shaped to have a vertical, lower leg 121 within the body 71 and a transverse, part cylindrical upper leg 123 within the body 71 joined to the top of the vertical, lower leg 121. One end of the upper leg 123 forms the entrance 118 in the side surface 119 of the lock block 71. The lower leg 121 tapers to an angled end wall 125 with an outer wall 127 angled away from an inner wall 129. The lock member 115 extends from within the vertical leg 121 into the cylindrical leg 123 and is biased out of the cylindrical leg 123, at an angle to the lock block 71, by a lock spring 131 within the cylindrical leg 123. The upper end 133 of the lock member 115 is normally out of the entrance 118 facing upwardly and outwardly in a locking position above the side surface 119 of the body 71 while the lower end 135 abuts the angled end wall 125 within the cavity 117. The outer surface 137 of the lock member 115 abuts outer wall 127 of the cavity 117 in the locking position.

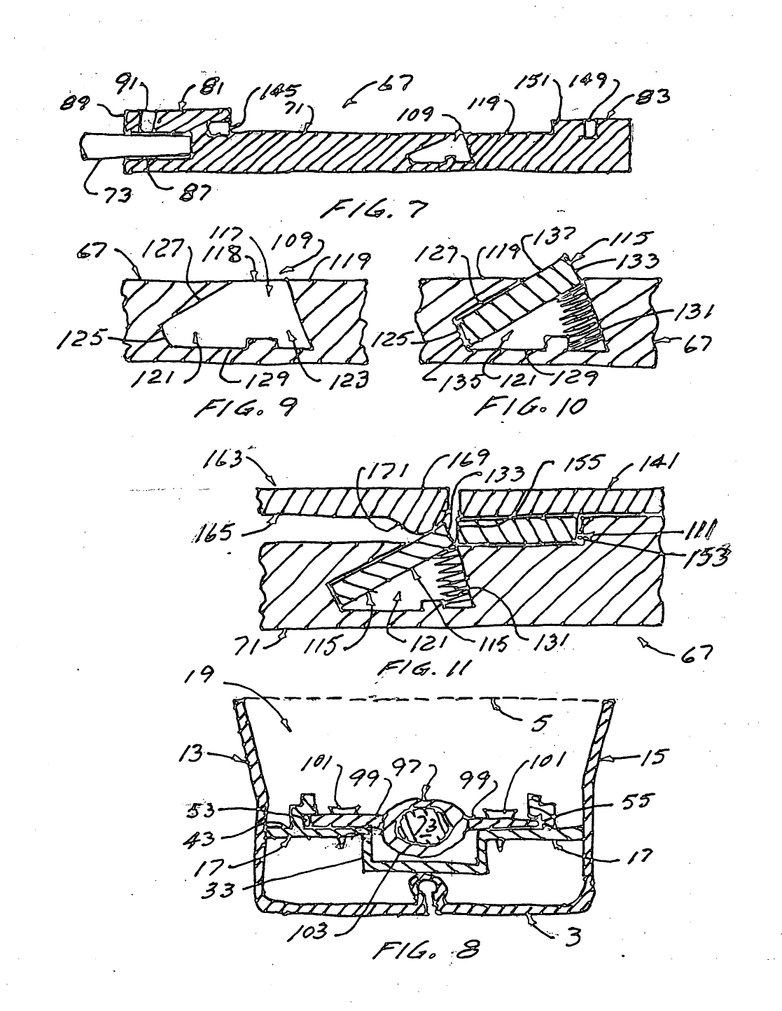

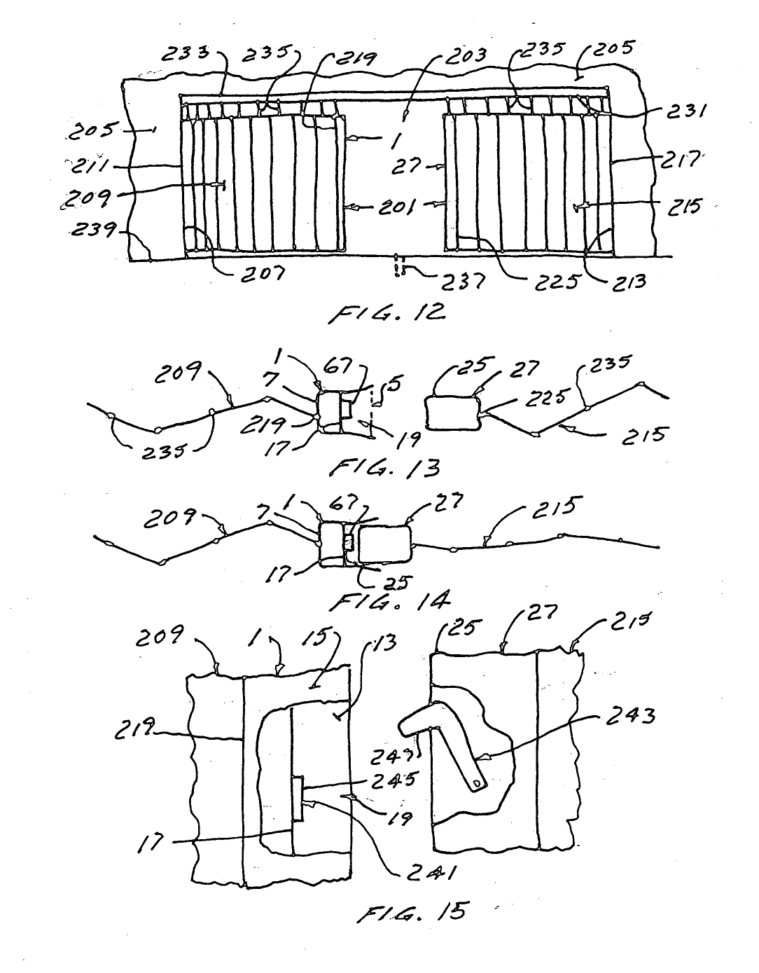

A cover 141, as shown in FIGS. 2 and 11, is provided on the operator 67 for retaining the lock member 115 in the cavity 117 in the locking position. The cover 141 is in the form of an elongate, thin, flexible plate and extends between the lower and upper guide sections 81, 83 of the operator 67 passing over the stop plate 111 on the interior wall 17. The lower end of the cover 141 has a tab 143 (FIG. 2) that fits in a slot 145 (FIG. 7) at the top of the lower guide section 81. The upper end of the cover 141 is fastened with a screw 147 on the top of the upper guide section 83. The upper guide section 83 has a threaded hole 149 in its top surface 151 for receiving the screw 147. The cover 141 faces the outer side 5 of the female post 1.

With the operator 67 in the raised, unlocked position, bearing against the stoppers 75 due to the action of the return spring 105, the operator 67 is positioned in the channel 33 to locate the lock member 115 just above the top edge 153 of the stop plate 111 as shown in FIG. 3. The lock member 115 projects outwardly and upwardly from the cavity 117 through the entrance 118. When the upper guide section 83 on the operator 67 is manually pressed down, through the post opening 19 in the outer side 5 of the female locking post 1, to move the operator 67 against the return spring 105 to a locked position, the lock member 115 is cammed down into the cavity 117, against the lock spring 131, by the fixed stop plate 111 bearing on the outer surface 137 of the raised lock member 115. The operator 67 is pushed down to have the lock member 115 clear the bottom edge 155 of the stop plate 111. As the lock member 115 clears the bottom edge 155 of the stop plate 123, during continued downward movement of the operator 67, the lock spring 131 moves the upper end 133 of the lock member 115 out of the entrance 117. At this point, the lock bolt 73 has been moved the required distance out of the bottom of the post. Release of the operator 67 causes the return spring 105 to push the operator 67 up until the upper end 133 of the lock member 115 abuts the bottom edge 155 of the stop plate 111, as shown in FIGS. 4 and 11, and thus locks the operator 67 and lock bolt 73 in the locked position.

A release 163 is provided on the cover 141 for unlocking the cooperating locking mechanisms 107, 109 to allow the operator 67, and thus the lock bolt 73, to be moved by the return spring 105 from the locked position to the unlocked position. In a particular embodiment, and as shown in FIGS. 2 and 11, release 163 includes an elongate finger 165 partially cut out in the cover 141, the finger 165 still attached to the cover 141 at its lower end 167 toward the lower end of the cover but extending upwardly to terminate at a top end 169 toward the top end of the cover. The top end 169 of the finger 165 is located just below the bottom edge 155 of the stop plate 111 in the locked position of the lock bolt 73. The finger 165 faces the outer side 5 of the female post 1. The cover 141 is made of flexible material and therefore the finger 165 is also flexible. The finger 165 has a protuberance 171 under its free top end 169 which overlies the upper portion of the lock member 115 adjacent its upper end 133. To unlock the lock bolt 73, the top end 169 of the flexible finger 165 is manually depressed to have its protuberance 171 press the lock member 115 into the cavity 117 against the lock spring 131 thus clearing the bottom edge 155 of the stop plate 111 and allowing the return spring 105 to move the operator 67, and thus the lock bolt 73, up to the unlocked position. The protuberance 171 is slightly rounded allowing it to ride over the bottom edge 155 of the stop plate 111 when the operator moves to the unlocked position. The resilient finger 165 is accessible to be manually depressed through the opening 19 in the outer side 5 of the female locking post 1. It is understood that any other appropriate type of release could alternatively be used.

An example of the use of the female locking post 1 with a two section folding closure 201 closing a building opening 203 in the wall 205 of a building is shown in FIGS. 12-14. The closure 201 has one end 207 of the first folding section 209 connected to one side 211 of the building opening 203, and one end 213 of the second folding section 215 connected to the other side 217 of the building opening 203. The other free end 219 of the first folding section 209 has a female locking post 1 mounted thereon. The inner wall 7 of the female post 1 is mounted on the free end 219 of the first folding section 209 via the slot 12 in the center of the inner wall 7. The outer side 5 of the female post 1 faces outwardly away from the first folding section 209. The post opening 19 in outer side 5 of the post provides access to the interior wall 17, the operator 67 mounted on the wall 17, and the release 163 within the post 1. The male locking post 27 is mounted on the free end 225 of the second folding section 215. The male post 27 is also a locking post for locking the male post to the female post. The first and second folding sections 209, 215 are suspended from a top rail 231 along the top 233 of the opening 203 by trolleys 235 projecting up from the top of the folding sections 209, 215 as is known.

When the building opening 203 is to be closed by the closure 201, the first folding section 209 is unfolded from the one side 211 of the building opening 203 and its female locking post 1 is located over a bore hole 237 in the floor 239 under the building opening 203. The vertical lock bolt 73 is carried by the interior wall 17 of the female locking post 1 within the bottom portion of the female post in an unlocked position. The operator 67 carrying the lock bolt 73 is accessible through the post opening 19 in the outer side 5 of the female post 1 and can be moved down by manual pressure applied to the top end of the body 71 of the operator 67. Downward movement of the operator 67 will insert the lock bolt 73 into the hole 237 in the floor 239 in a locked position to lock the first folding section 209 in its unfolded position against any lateral movement relative to the bore hole 237.

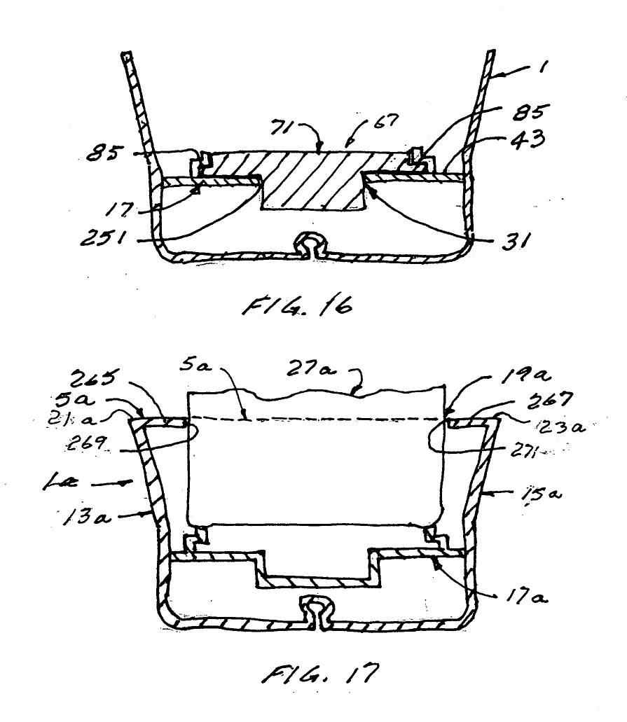

The second folding section 215, shown in FIGS. 13 and 14, is then unfolded from the other side 217 of the building opening 203 and the leading end 25 of its male locking post 27 is positioned partly within the female locking post 1, through the post opening 19 on the female post 1, to conceal the operator 67, including the lock bolt 73, within the female post 1. The male locking post 27 can abut the free ends 49, 51 of the locating members 39, 41 on the interior wall 17 within the female post 1. The male locking post 27, partly within the female locking post 1, is locked to the female post 1 with cooperating locking members 241, 243 on the female post 1 and the male post 27 respectively, as shown in FIG. 15, to lock the first and second folding sections 209, 215 together to have the folding closure 201 prevent access through the building opening 203. The male locking post 27, partly within the female post 1, closes post opening 19 and prevents the unlocking of the lock bolt 73.

The locking member 241 on the female locking post 1 could comprise a second lock plate 245, as shown in FIG. 15, located above the first lock plate 111 at about waist level. The second lock plate 245 would span the channel 33 and be fastened to the sides of the interior wall 17 defining the sides of the channel 33 by suitable fastening mechanisms such as screw fasteners (not shown). The locking member 243 on the locking post 27 could comprise a pivoted latch 247 that can be pivoted out of the post and over the second lock plate 245 and through the longitudinal wall opening 37 in the female post 1 when the locking post 27 is moved partly into the female post 1. It is understood that any other appropriate type of locking members can be alternatively used.

In the embodiment shown, the closure 201 is opened by unlocking the latch 247 and pulling the second section 215 away from the first section 209, the leading end 25 of the male locking post 27 moving out of the female locking post 1 to expose the operator 67 through the post opening 19 in the outer side 5 of the post. The elongate finger 165 of the release 163 can now be pressed to have the protuberance 171 press the free end 133 of the lock member 115 against its lock spring 131 till it clears the first lock plate 111. The return spring 105 on the lock bolt 73 then returns the operator 67 including the lock bolt 73 to its unlocked position within the female locking post 1 and both closure sections 209, 215 can be folded up and stored to open the building opening 203.

The guide structure 31 in the interior wall 17 of the female locking post 1 in another embodiment, can comprise a central, longitudinal slot 251 in the interior wall, as shown in FIG. 16, replacing the channel 33. The operator 67 would ride in the slot 251, supported by the wings 85, 93 on the upper and lower ends of the guide body 71 riding on the top surface 43 of the interior wall 17.

The female locking post 1 has been described with the outer side 5 of the post completely open to provide a longitudinal post opening 19 wide enough to receive the male locking post 27 of generally the same width as the female post 1. However, if a male locking post 27a narrower than the female locking post 1 is employed, as shown in FIG. 17, the outer side 5a of the female post la could be made partly open with narrow, outer, end walls 265, 267 extending toward each other from the respective outer edges 21a, 23a of the connecting walls 13a, 15a. The outer end walls 265, 267, transverse to the connecting walls 13a, 15a, are extensions of the side walls. The free edges 269, 271 of the outer end walls 265, 267 respectively, would define a post opening 19a between them sized to snugly receive the narrower locking post 27a. The opening 19a would still be wide enough to provide access to the interior wall 17a, and to the operator carried by wall 17a, when the locking post 27 is removed.

It will be seen that the operator 67 for the lock bolt 73 is mounted within the female locking post 1 and hidden by the male locking post 27 thus preventing unlocking of the closure when locked in a closed position. The operator 67 is centrally mounted within the female post la rather than on one connecting wall or the other connecting wall of the post. This allows the female locking post 1 be used on either section of the two-part closure. With an external operator, two different female locking posts are needed, one with an operator on one connecting wall of the post and another with the operator on the other connecting wall. The female locking post used is the post which places the external operator on the inside of the space to be enclosed by the unfolded closure. The operator 67, mounted within the female locking post 1 and covered by the male locking post, is unlikely to be damaged.

The above description is meant to be exemplary only, and one skilled in the art will recognize that changes may be made to the embodiments described without departing from the scope of the invention disclosed. Modifications which fall within the scope of the present invention will be apparent to those skilled in the art, in light of a review of the disclosure, and such modifications are intended to fall within the appended claims.

1. A female locking post for the free end of a first folding closure section in a two section folding closure; the female locking post having an inner side and an opposite outer side; the inner side comprising an inner wall for use in connecting the female post to the free end of the first folding closure section, the inner wall having two longitudinally opposed edges; two opposed connecting walls each joined to a respective one of the edges of the inner wall, the connecting walls extending from the inner wall of the post to its outer side; an interior wall extending between, and joined to, the connecting walls, the interior wall spaced from both the inner wall
and the outer side; the outer side of the post having a post opening; and an operator with a lock bolt, the operator movably mounted on the interior wall in a position where it is accessible through the post opening in the outer side, the operator movable along the interior wall, in a longitudinal direction between an unlocked position, where the lock bolt is within the post, and a locked position where the lock bolt projects from an end of the post.

2. A female locking post as claimed in claim 1 wherein the outer side of the female locking post is completely open to form the post opening.

3. A female locking post as claimed in claim 1 including cooperating locking mechanisms on the operator and the interior wall for locking the operator to the interior wall in the locked position.

4. A female locking post as claimed in claim 3 including a return spring between the operator and the interior wall for returning the operator to the unlocked position when the locking mechanisms are unlocked.

5. A female locking post as claimed in claim 3 including a release on the operator for unlocking the locking mechanisms, the release positioned to be accessible through the post opening in the outer side of the post.

6. A female locking post as claimed in claim 5 including a return spring between the operator and the interior wall for returning the operator to the unlocked position when the locking mechanisms are disengaged.

7. A female locking post as claimed in claim 3 including a longitudinal guide structure in the interior wall, the operator slidingly mounted within the guide structure.

8. A female locking post as claimed in claim 7 wherein the locking mechanism on the interior wall comprises a stop plate traversing the guide structure near one end of the post, the stop plate fixed to the interior wall and facing the outer side of the post.

9. A female locking post as claimed in claim 3 wherein the locking mechanisms include a lock member mounted in the operator to project slightly under spring bias from the operator toward the outer side.

10. A female locking post as claimed in claim 8 wherein the locking mechanisms include a lock member mounted in the operator to project slightly under spring bias from the operator toward the outer side, the projecting lock member abutting the side of the stop plate nearest the one end of the post in the locked position.

11. A female locking post as claimed in claim 3 including a release on the operator facing the outer side, the release accessible from the outer side to be manually moved against the locking mechanism on the operator to move the locking mechanism to disengage it from the locking mechanism on the interior wall.

12. A female locking post as claimed in claim 11 wherein the release comprises a resilient finger carried by the operator, a free end of the finger overlying the locking mechanism on the operator whereby depression of the finger against the locking mechanism moves the locking mechanism to disengage it from the locking mechanism on the interior wall.

13. A female locking post as claimed in claim 7 including a guide rail on each side of the guide structure on the outer surface of the interior wall extending the length of the post, the guide rails extending toward the outer side, each guide rail bent to form a shoulder defining a slot with the interior wall, the slot opening toward the guide structure, the guide rails extending past the operator, the operator having a first guide section at the lower end of the operator when the post is vertical, and a second guide section at the upper end of the operator, both guide sections having laterally extending wings positioned in the slots on each side of the guide structure to retain the operator in the guide structure.

14. A female locking post as claimed in claim 5 wherein the release includes a cover plate overlying and fastened to the operator at the ends of the operator, the cover plate facing the outer side, the cover plate having a resilient finger formed therein, the finger fastened at one end to the cover plate with the other end free, the other end overlying the locking mechanism on the operator, whereby when the other end is depressed it will unlock the locking mechanism on the operator from the locking mechanism on the interior wall.

15. A folding closure for closing an opening in a building, the folding closure comprising;
first and second folding sections having structure along a top thereof for suspending the sections from an overhead rail in the top of the opening, each section having one side configured for fastening the section to a respective side of the opening and an opposed free side;
a female post connected by an inner side to the free side of the first section and a locking post connected to the free side of the second section, the female post having an outer side opposite its inner side, the outer side facing the locking post and having a post opening, the female post having an operator within the post at a bottom end for locking the first section to a floor in the building, the operator operable through the post opening in the outer side of the female post; the locking post movable to the female post to close the post opening in the outer side when joining the sections together, the posts having cooperating locking members for locking the locking post to the female post when the locking post is at the female post.

16. A folding closure as claimed in claim 15 wherein the outer side of the female post is completely open to form the post opening, the post opening wide enough to receive the leading end of the locking post within the female post to conceal the operator when joining the sections together; the female post having an interior wall spaced from both the inner side and the outer side, the operator in the female post mounted on the interior wall and accessible from the post opening in the outer side, the locking post close to the interior wall when inserted in the post opening in the outer side of the female post to conceal the operator in the female post.

17. A folding closure as claimed in claim 16 wherein the operator in the female post has a lock bolt extending from one end, the operator movable down on the interior wall from an unlocked position to a locking position where the lock bolt extends out from the bottom of the post into a hole in the floor; and a locking mechanism for locking the operator in the locking position.

18. A folding closure as claimed in claim 17 including cooperating locking mechanisms on the operator and the interior wall for locking the operator in the locking position, and a release on the operator and accessible through the post opening, for disengaging the locking mechanism on the operator from the locking mechanism on the interior wall.

19. A folding closure as claimed in claim 18 wherein the release includes a cover plate overlying and fastened to the operator at ends of the operator, the cover plate facing the open outer end, the cover plate having a resilient finger formed therein, the finger fastened at one end to the cover plate with the other end free, the other end overlying the locking mechanism on the operator in the locking position, whereby when the other end is depressed it will disengage the locking mechanism on the operator from the locking mechanism on the interior wall.

20. A folding closure as claimed in claim 16 including a longitudinal guide structure in the interior wall, the operator slidingly mounted within the guide structure; a guide rail on each side of the guide structure on an the inner surface of the interior wall extending the length of the post, the guide rails extending toward the outer side, each guide rail bent to form a shoulder defining a slot with the interior wall, the slot opening toward the guide structure, the operator having a first guide section at a lower end of the operator when the post is vertical, and a second guide section at an upper end of the operator, both guide sections having laterally extending wings positioned in the slots on each side of the guide structure to retain the operator in the guide structure.
